(19) United States
(12) Patent Application Publication
(10) Pub. No.: US 2015/0169430 A1
(43) Pub. Date: Jun. 18, 2015

(54) SELECTING WEBPAGE TEST PATHS

(71) Applicant: International Business Machines Corporation, Armonk, NY (US)

(72) Inventors: Bai Chen Deng, Beijing (CN); Qing Hua Feng, Beijing (CN); Jia Lin Li, Beijing (CN); Jun Hua Wang, Beijing (CN); Shi Wan Zhao, Beijing (CN)

(73) Assignee: International Business Machines Corporation, Armonk, NY (US)

(21) Appl. No.: 14/105,892

(22) Filed: Dec. 13, 2013

(51) Int. Cl. G06F 11/36

(52) U.S. Cl. CPC G06F 11/3676

(57) ABSTRACT

A method for selecting webpage test paths includes segmenting a current webpage into blocks; performing operations on a representative interactive element contained in a user concerned block to proceed to a next webpage; iteratively repeating the segmenting and the performing on a next webpage until an ending webpage; recording webpage test paths from the beginning webpage to the ending webpage; and determining importance degrees of the webpage test paths and selecting webpage test paths to be test according to the importance degrees.

### BACKGROUND

The present invention relates to webpage testing, and more specifically, to a method and apparatus for selecting webpage test paths.

With the rapid development of webpage techniques, more and more webpage applications have been developed and deployed, wherein Web 2.0 and HTML 5 are techniques that are applied more extensively. In order to guarantee the correctness and accuracy of webpage applications, technologies for automatic testing webpages become increasingly important. In order to improve test efficiency, currently several tools for automatic testing have been provided. When performing webpage tests using these automatic test tools, testers usually execute a series of operation actions on webpages under test in a recording mode of the automatic test tools. In this process, the automatic test tools automatically record test scripts according to actions performed by the testers, and the testers can playback operation steps using the test tools.

However, due to restricted resources and time, it is in fact impossible for a webpage tester to always perform comprehensive testing for each test, as a result, some important test holes may be omitted, and thus the quality of webpage applications may be significantly affected. With the application of ASP, JSP, CSS and JavaScript in Web techniques, webpages are dynamic, for which exhaustive testing is impossible, and test coverage generally depends on the experience and knowledge of webpage testers. Increasing test coverage may consume a large amount of human efforts and time. Current tools do not support test path identification and test coverage maximization under restricted resource and time conditions.

Therefore, it is desirable to provide a technical solution allowing a webpage tester to complete systematic test tasks efficiently under a restricted resource condition.

### SUMMARY

In one embodiment, a method for selecting webpage test paths includes segmenting a current webpage into blocks; performing operations on a representative interactive element contained in a user concerned block to proceed to a next webpage; iteratively repeating the segmenting and the performing on a next webpage until an ending webpage; recording webpage test paths from the beginning webpage to the ending webpage; and determining importance degrees of the webpage test paths and selecting webpage test paths to be test according to the importance degrees.

In another embodiment, an apparatus for selecting webpage test paths, includes a segmentation module, configured to segment a current webpage into blocks, to perform operations on a representative interactive element contained in a user concerned block to proceed to a next webpage, and to iteratively repeat the segmenting and the performing on a next webpage until an ending webpage; a recording module, configured to record webpage test paths from the beginning webpage to the ending webpage; and a test path selection module, configured to determine importance degrees of the webpage test paths and to select webpage test paths to be test according to the importance degrees.

### BRIEF DESCRIPTION OF THE SEVERAL VIEWS OF THE DRAWINGS

Through the more detailed description of some embodiments of the present disclosure in the accompanying drawings, the above and other objects, features and advantages of the present disclosure will become more apparent, wherein the same reference generally refers to the same components in the embodiments of the present disclosure.

FIG. 1 shows a block diagram of an exemplary computer system/server which is applicable to implement the embodiments of the present invention;

FIG. 2 shows a method for selecting webpage test paths according to an embodiment of the present invention;

FIG. 3 shows an embodiment of selecting webpage test paths of the present invention;

FIG. 4 shows a webpage state transition diagram according to an embodiment of the present invention; and

FIG. 5 shows an apparatus for selecting webpage test paths according to an embodiment of the present invention;

### DETAILED DESCRIPTION

According to one embodiment of the present invention, there is provided a method for selecting webpage test paths, comprising: segmenting a current webpage into blocks; performing operations on a representative interactive element contained in a user concerned block to proceed to a next webpage; performing the above steps iteratively on a next webpage until an ending webpage; recording webpage test paths from the beginning webpage to the ending webpage; determining importance degrees of the webpage test paths and selecting webpage test paths to be test according to the importance degrees.

According to another embodiment of the present invention, there is provided an apparatus for selecting webpage test paths, comprising a segmentation module, configured to segment a current webpage into blocks, to perform operations on a representative interactive element contained in a user concerned block to proceed to a next webpage, and to perform the above operations iteratively on a next webpage until an ending webpage; a recording module, configured to record webpage test paths from the beginning webpage to the ending webpage; a test path selection module, configured to determine importance degrees of the webpage test paths and to select webpage test paths to be test according to the importance degrees.

According to the method and apparatus for selecting webpage test paths according to embodiments of the present invention, a webpage tester is enabled to complete systematic test tasks efficiently under restricted resource conditions.

Exemplary embodiments will be described in more detail with reference to the accompanying drawings, in which the preferable embodiments of the present disclosure have been illustrated. However, the present disclosure can be implemented in various manners, and thus should not be construed to be restricted to the embodiments disclosed herein. On the contrary, those embodiments are provided for the thorough and complete understanding of the present disclosure, and completely conveying the scope of the present disclosure to those skilled in the art.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not restricted to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not restricted to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not restricted to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

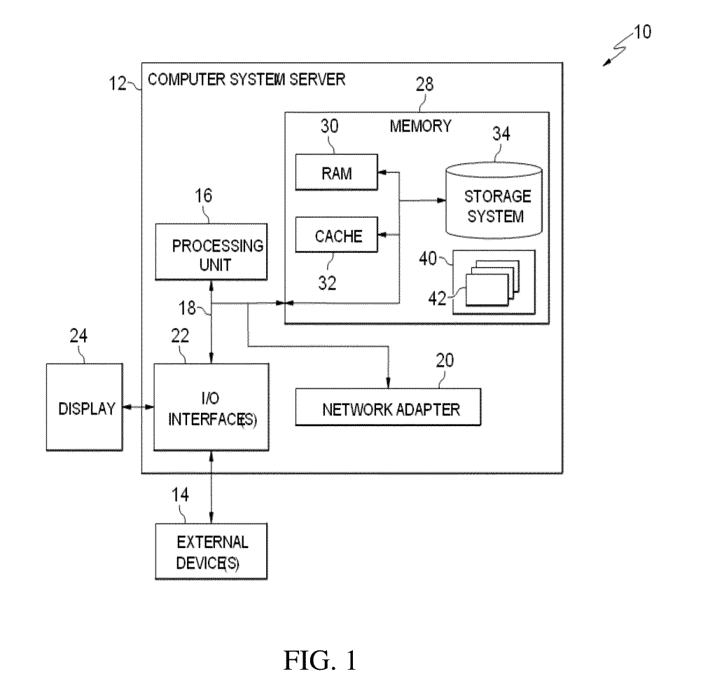

Referring now to FIG. 1, in which an exemplary computer system/server 12 which is applicable to implement the embodiments of the present invention is shown. Computer system/server 12 is only illustrative and is not intended to suggest any limitation as to the scope of use or functionality of embodiments of the invention described herein.

As shown in FIG. 1, computer system/server 12 is shown in the form of a general-purpose computing device. The components of computer system/server 12 may include, but are not restricted to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not restricted to: microcode, device drivers, redundant processing units, external disk drive arrays, RAID systems, tape drives, and data archival storage systems, etc.

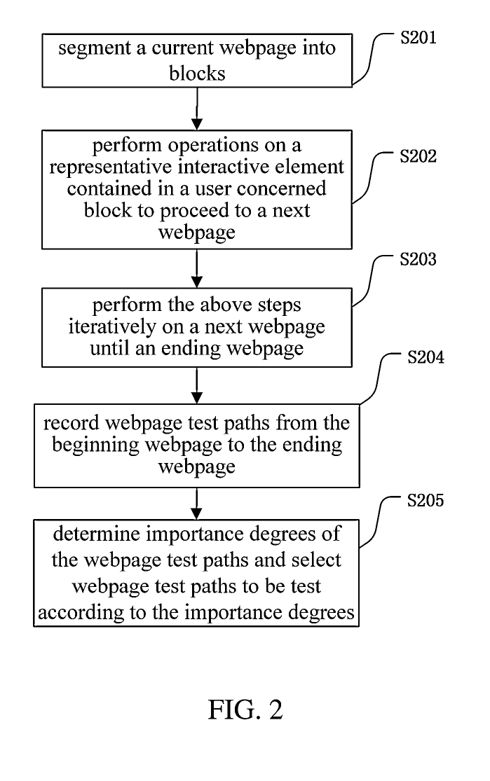

FIG. 2 shows a method for selecting webpage test paths according to an embodiment of the present invention. The method includes: at block S201, segmenting a current webpage into blocks, for example, segmenting according to visualization features of the current webpage; at block S202, performing operations on a representative interactive element contained in a user concerned block to proceed to a next webpage; at block S203, performing the above operations iteratively on a next webpage until an ending webpage; at block S204, recording webpage test paths from the beginning webpage to the ending webpage; at block S205, determining importance degrees of the webpage test paths and selecting webpage test paths to be test according to the importance degrees.

At block S201, a current webpage is segmented into blocks. The segmentation can be performed according to a DOM tree structure of the current webpage. VIPS (Vision-based Page Segmentation Algorithm) is a webpage segmentation algorithm based on the visual features, which is proposed by Microsoft and widely used nowadays. The VIPS performs webpage semantic segmentation using webpage visual features, such as background colors, font colors and sizes, borders, distances between logic blocks, etc, in conjunction with a DOM tree. The VIPS algorithm mainly comprises three operations: webpage block extraction, separator exaction, and semantic block reconstruction. First of all, it extracts all appropriate webpage blocks from the DOM tree, and then detects all separators therebetween according to these webpage blocks, comprising separators in the horizontal and vertical directions; at last, a semantic structure of the webpage is reconstructed based on these separators. For each semantic block, it can be further segmented into smaller semantic blocks using the VIPS algorithm.

A webpage is, at first, partitioned into several larger semantic blocks, while a hierarchical structure composed of those semantic blocks is recorded. For each larger semantic block detected, it can be further segmented continually, until the DOC (Degree of Coherence) value thereof reaches a predetermined PDOC (Permitted Degree of Coherence) value. In each iterative loop, a DOM tree structure of a current logic block and its visual information are acquired. Then, from the root node of the DOM tree, a logic block detection process begins to detect webpage blocks from the DOM tree based on the visual information. Each DOM node is checked to determine whether it can form a separate webpage block. If not, the same check is performed on its sub-nodes. A DOC value is assigned to each extracted webpage block according to internal visual features of the current webpage block. When all webpage blocks have been detected in this iteration process, they are stored in a webpage pool. Based on these webpage blocks, a separator detection process begins to work. All horizontal separators and vertical separators between these webpage blocks are finally identified and assigned with certain width and height values respectively. Based on these separators, the layout of the webpage is reconstructed, consolidating some webpage blocks to form semantic blocks. At last, all semantic blocks are detected in this iteration process.

Whether to continue the iteration process depends on whether there is a semantic block having a DOC value less than PDOC among the semantic blocks in this level. For those semantic blocks having DOC≧PDOC, the partition process terminates, otherwise the partition process continues. When all semantic blocks have been extracted, the segmentation process based on visual features is complete for the whole webpage.

Those skilled in the art should understand that segmenting a current webpage can be realized in many manners, and the present invention does not have limitation thereto, all of which fall within the scope of the present invention, so long as they can realize the segmentation of a current webpage.

At block S202, operations are performed on a representative interactive element contained in a user concerned block to proceed to a next webpage. A user may select a concerned block from the blocks of the webpage as required. Each block of the webpage comprises at least one interactive element, or some block may comprise even dozens of interactive elements, including hyperlinks, interactive forms, buttons, user registries, file upload fields and text fields. According to an embodiment of the present invention, the method further includes: identifying interactive elements contained in the user concerned block; classifying the interactive elements according to the target objects of those interactive elements; taking interactive elements having similar target objects as the same type of interactive element, for example, if two or more interactive objects have similar skip destination webpages as their target objects, that is, the skip destination webpages have similar webpage templates or addresses, the two or more interactive elements can be classified into one type of interactive element; randomly selecting at least one interactive element from the same type of interactive element as a representative interactive element. According to an embodiment of the present invention, further comprising: recording the operations performed on the representative interactive element; generating a webpage test script according to the recorded operation for playback later.

At block S203, the above operations are performed on the next webpage, until an ending webpage, that is, the next webpage is segmented based on its visual features, and a representative interactive element contained in a block is operated to proceed to another next webpage and repeated so, until an ending webpage.

At block S204, a webpage test path from a beginning webpage to an ending webpage is recorded. Through a user selecting a concerned block in the webpage, a concerned webpage test path can be obtained at last. According to an embodiment of the present invention, the user can select all blocks, some blocks in a webpage, or the system can make an automatic selection. According to an embodiment of the present invention, further comprising: recording state transitions of the webpage test paths, and storing the state transitions into a state transition diagram. The user can manually modify the state transition diagram to change or remove some test paths or input data. A next webpage is accessed through a representative interactive element in a block, since the selected representative interactive element can represent a type of interactive element with the similar target objects, it is not necessary to traverse all interactive elements to find out a webpage test path, simplifying the process of searching a webpage test path, while maximizing the coverage of webpage test paths, without omitting any webpage test path in a selected range.

At block S205, the importance degrees of those webpage test paths are determined, and webpage test paths to be test are selected according to the importance degrees. According to an embodiment of the present invention, the importance degrees of webpages contained in a webpage test path are determined, and the importance degree of the webpage test path is determined according to the importance degrees of the webpages contained in the webpage test path, wherein determining the importance degrees of webpages contained in a webpage test path comprises: determining the importance degree of a user concerned block; determining the importance degree of a webpage accessed through a representative interactive element contained in the user concerned block according to the importance degree of the user concerned block. Wherein, the importance degree of the user concerned block is related to at least one of the following factors: the size of the block, the position of the block, the function of the block, the access frequency of the block and the error frequency of the block. A weight calculation rule is set according to the above factors to calculate a weight value for each block in the webpage. Under a restricted resource condition, network test paths with higher importance degrees are preferably selected for testing, so that test efficiency can be improved for a network tester.

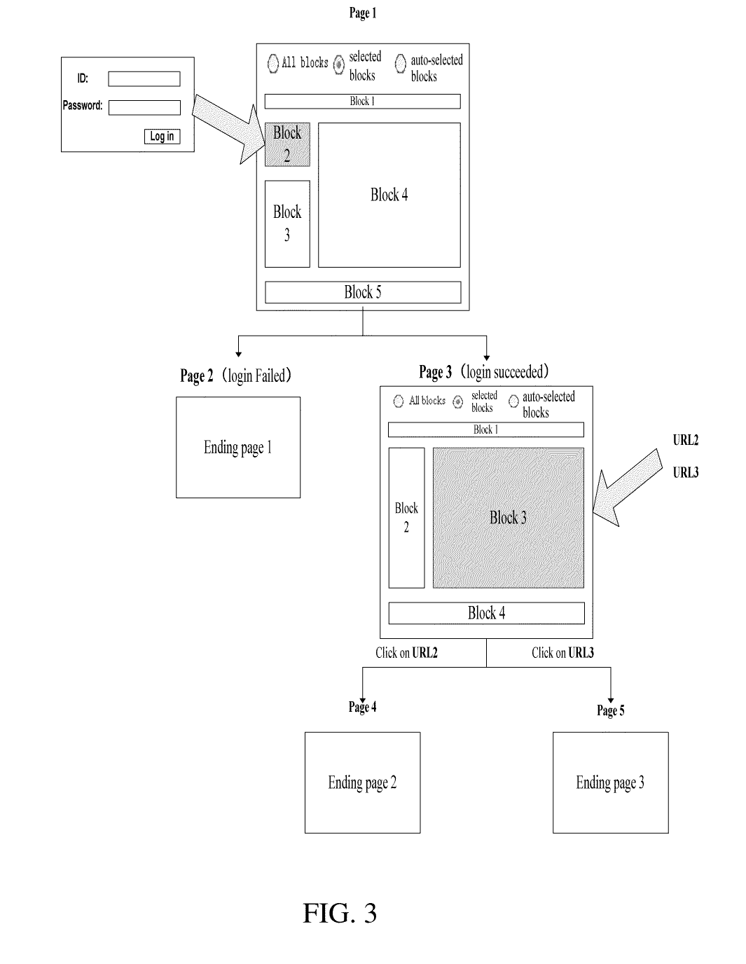

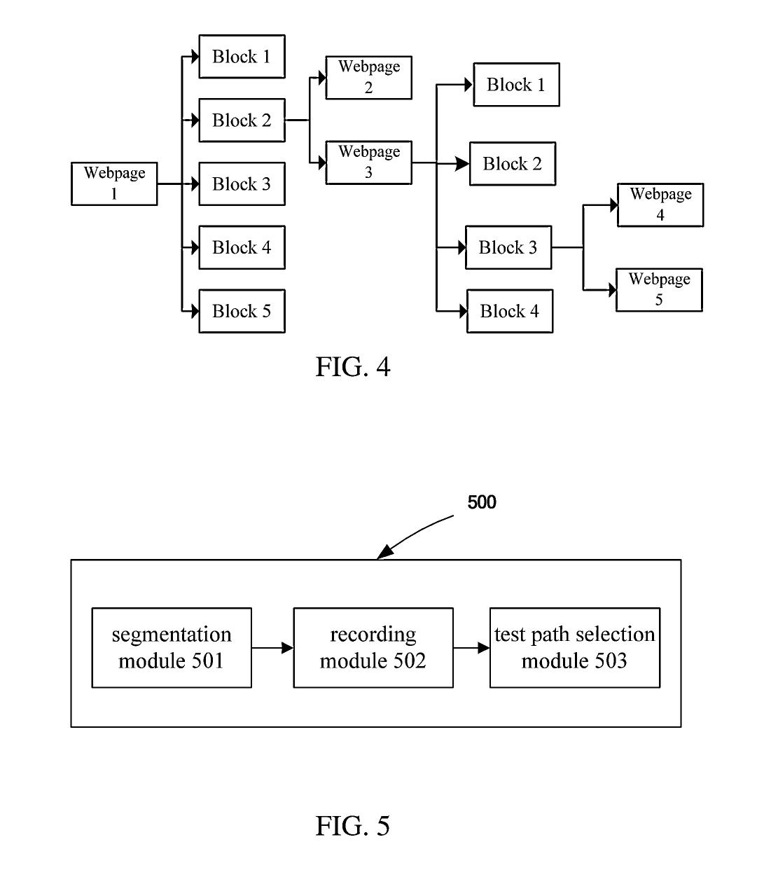

FIG. 3 shows an embodiment of selecting webpage test paths of the present invention. A user proceeds to webpage1 through URL1, wherein webpage1 is segmented into 5 blocks according to the visualization features of webpage1, a block 2 is selected by the user as a concerned block, and a representative interactive element identified from block 2 is a login box, in which a user ID and a password are entered to log in, if the login fails, a webpage 2 is entered, which is an ending webpage, if the login succeeds, a webpage 3 is entered, which is segmented into 4 blocks according to the visualization features of the webpage 3, and a block 3 is selected by the user as a concerned block; URL2 and URL3 are identified as representative interactive elements from the block 3, URL2 is clicked to proceed to a webpage 4, and URL3 is clicked to proceed to a webpage 5, which are both ending webpages. FIG. 4 shows a webpage state transition diagram of this embodiment of the present invention, in which identified webpage test paths are:

webpage test path 1: webpage 1→webpage 2;
webpage test path 2: webpage 1→webpage 3→webpage 4;
webpage test path 3: webpage 1→webpage 3→webpage 5;

According to this embodiment of the present invention, a simple rule is set for the weights of the blocks in webpage 1 and webpage 3: weight (block)=block size*W (position of the block), wherein the block size is the ratio of the block to the whole webpage, which can be obtained through a DOM API, the larger the block is, the higher the weight is. W (position of the block) is a position weight of the block, a webpage is partitioned into different regions with different weights assigned, and a block located in a region has a corresponding weight value. Table 1 shows the weights of the blocks in webpage 1, and Table 2 shows the weights of the blocks in webpage 2.

TABLE 1
Weight of blocks in webpage 1

| | Block 1 | Block 2 | Block 3 | Block 4 | Block 5 |
|---|---|---|---|---|---|
| Block size | 0.05 | 0.05 | 0.1 | 0.75 | 0.05 |
| W (position of | 3.0 | 3.0 | 2.0 | 4.0 | 1.0 |
| the block) | | | | | |
| Weight (block) | 0.15 | 0.15 | 0.2 | 3.0 | 0.05 |

TABLE 2
Weights of blocks in webpage 2

| | Block 1 | Block 2 | Block 3 | Block 4 | Block 5 |
|---|---|---|---|---|---|
| Block size | 0.05 | 0.15 | 0.75 | 0.05 | 0.05 |
| W (position of | 3.0 | 3.0 | 4.0 | 1.0 | 3.0 |
| the block) | | | | | |
| Weight (block) | 0.15 | 0.45 | 3.0 | 0.05 | 0.15 |

Webpage test path 1 is: webpage 1→webpage 2;

As for webpage 1, its weight is assumed to be 1.0,

Because webpage 2 is accessed through a representative interactive element in the block 2 of the webpage 1, the weight of webpage 2 is set to the weight 0.15 of the block 2;

The weight of the webpage test path 1 is W(path1)=1.0*0.15=0.15.

For webpage test path 2: webpage 1→webpage 3→webpage 4;

As for webpage 1, its weight is assumed to be 1.0;

Webpage 3 is accessed through a representative interactive element in block 2 of webpage 1, therefore the weight of webpage 3 is set to the weight 0.15 of block 2 of webpage 1;

Webpage 4 is accessed through a representative interactive element in block 3 of webpage 3, so that the weight of webpage 4 is set to the weight 3.0 of block 3 of webpage 3;

The weight of the webpage test path 2 is W(path2)=1.0*0.15*3.0=0.45.

For webpage test path 3: webpage 1→webpage 3→webpage 5;

Webpage 3 is accessed through a representative interactive element in block 2 of webpage 1, therefore the weight of webpage 3 is set to the weight 0.15 of block 2 of webpage 1;

Webpage 4 is accessed through a representative interactive element in block 3 of webpage 3, so that the weight of webpage 4 is set to the weight 3.0 of block 3 of webpage 3;

The weight of the webpage test path 3 is W(path3)=1.0*0.15*3.0=0.45.

Therefore, those webpage test paths are sorted according to their importance degrees:

Webpage test path 2, webpage test path 3>webpage test path 1.

Under a restricted resource condition, a tester can preferably select webpage test paths with higher importance degrees for testing.

An apparatus for selecting webpage test paths is also provided in an embodiment of the present invention. FIG. 5 shows an apparatus 500 for selecting webpage test paths according to an embodiment of the present invention, comprising: a segmentation module 501, configured to segment a current webpage into blocks, to perform operations on a representative interactive element contained in a user concerned block to proceed to a next webpage, and to perform the above operations iteratively on a next webpage until an ending webpage; a recording module 502, configured to record webpage test paths from the beginning webpage to the ending webpage; a test path selection module 503, configured to determine importance degrees of the webpage test paths and to select webpage test paths to be test according to the importance degrees.

According to an embodiment of the present invention, the segmentation module 501 comprises: an identification module, configured to identify interactive elements contained in the user concerned block; a classification module, configured to classify the interactive elements according to the target objects of those interactive elements, and to take the interactive elements having similar target objects as the same type of interactive elements; a selection module, configured to randomly select at least one interactive element from the same type of interactive elements as a representative interactive element.

According to an embodiment of the present invention, the test path selection module is configured to determine the importance degrees of webpages contained in a webpage test path; and determine the importance degree of the webpage test path according to the importance degrees of the webpages contained in the webpage test path.

According to an embodiment of the present invention, the test path selection module is configured to determine the importance degree of a user concerned block; determine the importance degree of a webpage that is accessed through a representative interactive element contained in the user concerned block according to the importance degree of the user concerned block.

According to an embodiment of the present invention, the importance degree of the user concerned block is related to at least one of the following factors: size of the block, position of the block, access frequency of the block and error frequency of the block.

According to an embodiment of the present invention, wherein the segmentation module 501 further comprises: an operation recording module, configured to record the operations performed on the representative interactive element; a test script generation module, configured to generate a webpage test script according to the recorded operations.

According to an embodiment of the present invention, the recoding module is further configured to record state transitions of the webpage test paths, and to store the state transitions in a state transition diagram.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration, but are not intended to be exhaustive or restricted to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A method for selecting webpage test paths, comprising:
segmenting a current webpage into blocks;
performing operations on a representative interactive element contained in a user concerned block to proceed to a next webpage;
iteratively repeating the segmenting and the performing on a next webpage until an ending webpage;
recording webpage test paths from the beginning webpage to the ending webpage; and
determining importance degrees of the webpage test paths and selecting webpage test paths to be test according to the importance degrees.

2. The method according to claim 1, wherein the performing operations on a representative interactive element contained in a user concerned block to proceed to a next webpage comprises:
identifying interactive elements contained in the user concerned block;
classifying the interactive elements according to the target objects of those interactive elements, and taking the interactive elements having similar target objects as the same type of interactive elements; and
randomly selecting at least one interactive element from the same type of interactive elements as a representative interactive element.

3. The method according to claim 1, wherein determining importance degrees of the webpage test paths comprises:
determining the importance degrees of webpages contained in a webpage test path; determining the importance degree of the webpage test path according to the importance degrees of the webpages contained in the webpage test path.

4. The method according to claim 3, wherein determining the importance degrees of webpages contained in a webpage test path comprises:
determining the importance degree of a user concerned block; and
determining the importance degree of a webpage that is accessed through a representative interactive element contained in the user concerned block according to the importance degree of the user concerned block.

5. The method according to claim 4, wherein the importance degree of the user concerned block is related to at least one of the following factors: size of the block, position of the block, access frequency of the block and error frequency of the block.

6. The method according to claim 1, wherein performing operations on a representative interactive element contained in a user concerned block to proceed to a next webpage comprises:
recording the operations performed on the representative interactive element; and
generating a webpage test script according to the recorded operations.

7. The method according to claim 1, wherein recording webpage test paths from the beginning webpage to the ending webpage further comprises:
recording state transitions of the webpage test paths, and storing the state transitions in a state transition diagram.

8. An apparatus for selecting webpage test paths, comprising:
a segmentation module, configured to segment a current webpage into blocks, to perform operations on a representative interactive element contained in a user concerned block to proceed to a next webpage, and to iteratively repeat the segmenting and the performing on a next webpage until an ending webpage;
a recording module, configured to record webpage test paths from the beginning webpage to the ending webpage; and
a test path selection module, configured to determine importance degrees of the webpage test paths and to select webpage test paths to be test according to the importance degrees.

9. The apparatus according to claim 8, wherein the segmentation module comprises:
an identification module, configured to identify interactive elements contained in the user concerned block;
a classification module, configured to classify the interactive elements according to the target objects of those interactive elements, and to take the interactive elements having similar target objects as the same type of interactive elements; and
a selection module, configured to randomly select at least one interactive element from the same type of interactive elements as a representative interactive element.

10. The apparatus according to claim 8, wherein the test path selection module is configured to:
determine the importance degrees of webpages contained in a webpage test path; and
determine the importance degree of the webpage test path according to the importance degrees of the webpages contained in the webpage test path.

11. The apparatus according to claim 10, wherein the test path selection module is further configured to:
determine the importance degree of a user concerned block; and
determine the importance degree of a webpage that is accessed through a representative interactive element contained in the user concerned block according to the importance degree of the user concerned block.

12. The apparatus according to claim 11, wherein the importance degree of the user concerned block is related to at least one of the following factors: size of the block, position of the block, access frequency of the block and error frequency of the block.

13. The apparatus according to claim 8, wherein the segmentation module further comprises:
an operation recording module, configured to record the operations performed on the representative interactive element; and
a test script generation module, configured to generate a webpage test script according to the recorded operations.

14. The apparatus according to claim 8, wherein the recoding module is further configured to record state transitions of the webpage test paths, and to store the state transitions in a state transition diagram.
